(19) United States
(12) Patent Application Publication
(10) Pub. No.: US 2013/0236271 A1
(43) Pub. Date: Sep. 12, 2013

(54) Hay Bale Spear Implement

(71) Applicant: Lance Lehmann, Brenham, TX (US)

(72) Inventor: Lance Lehmann, Brenham, TX (US)

(21) Appl. No.: 13/413,896

(22) Filed: Mar. 7, 2012

(51) Int. Cl. A01D 90/00

(52) U.S. Cl. 414/24.5

(57) ABSTRACT

An improved hay bale spear implement comprises multiple spears and multiple support spikes extending outwardly from a frame. The arrangement of the spears and support spikes enables one or more spears and one or more support spikes to penetrate and support a single large round hay bale, two large round hay bales, or a large rectangular hay bale. The spears and support spikes may be positionable at various locations along the frame by a user of the implement. An attachment device couples the frame to a vehicle such as a tractor or loader. The attachment device may be removable from the frame to enable installation of a different type of attachment device to the frame.

### FIELD OF DISCLOSURE

This disclosure relates generally to an implement to secure hay bales for transportation from one location to another. More particularly, but not by way of limitation, this disclosure is related to an improved hay bale spear designed to accommodate bales of different sizes and dimensions and to secure multiple bales simultaneously.

### BACKGROUND

Grasses form the basis of the diet for all grazing animals. Fields of growing grasses, legumes, and occasionally grain crops are commonly cut during the growing season, allowed to dry, and stored as hay for use as animal fodder during the winter. The haymaking process consists of the steps of cutting, drying, processing, and storing hay. Hay is typically cut and allowed to dry in the field before it is gathered and baled for storage, handling, and transportation.

Hay balers produce bales of various shapes and dimensions. Small rectangular bales are typically 14 or 16 inches in height and 18 inches deep. The length of these small rectangular bales varies based on the particular baler. Small rectangular bales can be handled by one person without the need for transportation equipment. Thus, small rectangular bales may be preferred by farmers or ranchers with small numbers of livestock. However, due to the small ratio of volume to surface area as compared to larger bales, small rectangular bales are commonly stored in a shelter to avoid moisture that may cause the hay to mold or rot, rendering the hay unusable.

Accordingly, many farmers and ranchers, especially those producing hay for large herds or for sale, have transitioned to balers that produce large hay bales. These large, densely packed hay bales maximize the amount of hay that is protected from the environment and are therefore commonly stored outdoors. Large bales, too, come in various shapes and dimensions. Large rectangular bales vary from 3 to 4 feet in both height and depth and from 3 to 9 feet in length. Large round bales vary from 2.5 to 6 feet in diameter and from 3 to more than 5 feet in width. While large rectangular and round hay bales are convenient in that they greatly reduce the number of bales that are produced and handled and allow for outdoor storage, they also create the need for machinery to transport the bales, because, depending on the size of the bale, the type of hay, and the moisture content, large bales may weigh over 2,000 pounds.

Farmers often use buckets attached to tractors or loaders to transport large hay bales. Generally, these types of buckets require a person other than the person operating the equipment to guide the bale to a proper position on or within the bucket. However, a bucket may not properly secure large bales, leading to a risk of property damage and personal injury. Accordingly, various bale spears, attachable to loaders and tractors, have been developed to penetrate hay bales and support the bale as it is transported to a desired location. While these spears allow the operator of the loader or tractor alone to approach a hay bale, insert the spear, and securely transport the bale to a desired location, existing hay bale spears are dedicated to transporting either a single large round bale or single large rectangular bale and cannot be utilized to transport various sizes of round and rectangular bales or to transport multiple round bales simultaneously. There is therefore a need in the art to overcome these deficiencies.

### BRIEF DESCRIPTION OF THE DRAWINGS

FIG. 1 is a top view of an improved hay bale spear implement in accordance with one embodiment.

FIG. 2 is a side view of an improved hay bale spear implement in accordance with one embodiment.

FIG. 3 is a front view of an improved hay bale spear implement in accordance with one embodiment.

FIG. 4 is a perspective view of an improved hay bale spear implement in accordance with one embodiment.

FIG. 5 is a front view of an improved hay bale spear implement depicting an orientation in which two large round bales are simultaneously supported by the implement in accordance with one embodiment.

FIG. 6 is a front view of an improved hay bale spear implement depicting an orientation in which a single large round bale is supported by the implement in accordance with one embodiment.

FIG. 7 is a front view of an improved hay bale spear implement depicting an orientation in which a large rectangular bale is supported by the implement in accordance with one embodiment.

FIG. 8 is a perspective view of an improved hay bale spear implement in which the spears and spikes can be positioned in a user-customizable manner along the length of the implement in accordance with one embodiment.

### DETAILED DESCRIPTION

Various embodiments, described in more detail below, provide a description of an improved hay bale spear apparatus configured to secure one or more large hay bales of various sizes. The detailed description will present information to enable one of ordinary skill in the art of agricultural implements to understand the disclosed apparatus.

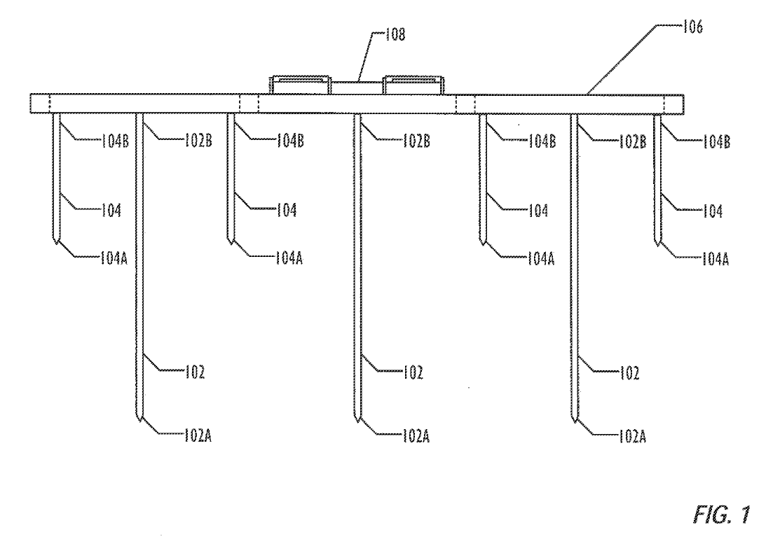

FIG. 1 illustrates a top view of an improved hay bale spear implement in accordance with an embodiment of the disclosure. In the depicted embodiment, three bale spears 102 and four support spikes 104 extend outwardly from the frame 106 of the implement. The spears 102 typically range from 30 to 50 inches in length and from 1½ to 2 inches in diameter at their base 102b. Although the spears 102 are depicted as substantially uniform in cross-section along their length (tapering only very near point 102a in the depicted embodiment), the spears may also be tapered along their entire length or some substantial portion thereof from the base 102b to the point 102a. The spears 102 extend deep into a hay bale and serve as the primary means of supporting the weight of the hay bale. The shorter support spikes 104 typically range from 12 to 24 inches in length and from 1½ to 2 inches in diameter at their base 104b. Like the spears 102, the support spikes 104 may have a substantially uniform cross-section (tapering only very near the point 104a) or may be tapered along their entire length or some substantial portion thereof from the base 104b to the point 104a. The support spikes 104, although shorter than the spears 102, extend into a hay bale and serve to stabilize the bale on the spear 102. For example, the support spikes 104 may prevent the rotation of a large round bale about a spear 102 penetrating the bale as the bale is transported.

The spears 102 and support spikes 104 may be secured to the frame 106 in a variety of manners. In one embodiment, the base of a spear 102 or support spike 104 may be permanently welded to the frame 106. In one embodiment, a threaded portion of the base of a spear 102 or support spike 104 may be threadedly engaged in a threaded socket in the frame 106. In another embodiment, a threaded portion of the base of a spear 102 or support spike 104 may extend through a hole in the frame 106 with the spear 102 or support spike 104 secured to the frame 106 by means of a nut and washer attached on the opposite side of the frame 106. In another embodiment, a sleeve may be welded into a socket of the frame 106 and a spear 102 or support spike 104 may be secured in the sleeve by means of a cross-bolt extending radially through the sleeve and the spear 102 or support spike 104. Thus, in various embodiments, the spears 102 and support spikes 104 are easily removable from the frame 106. As such, spears 102 and support spikes 104 of the proper dimensions for a particular task can be quickly installed and damaged spears 102 and spikes 104 can be replaced. Additional means of securing the spears 102 and support spikes 104 to the frame 106 will be apparent to those of ordinary skill in the art.

Also illustrated in FIG. 1 is an attachment device 108 for securing the hay bale spear implement to a vehicle such as a tractor or loader. In one embodiment, the attachment device 108 is a Skid Steer Quick Attach device which, as is known by those skilled in the art, is quickly attachable and detachable to a corresponding fitting on a vehicle. In another embodiment, as will be described in greater detail below, different attachment devices 108 may be easily installed and removed from the frame 106 such that the implement can be utilized with various vehicles.

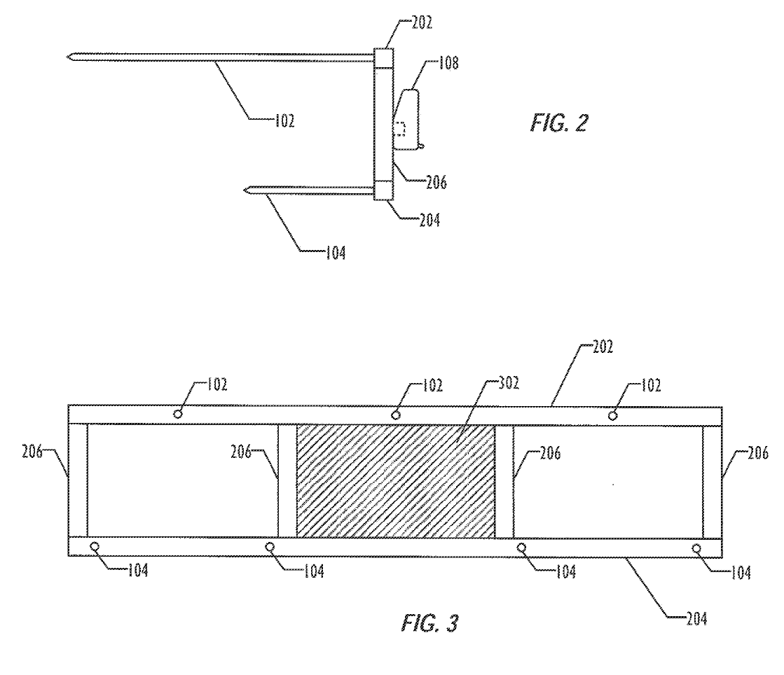

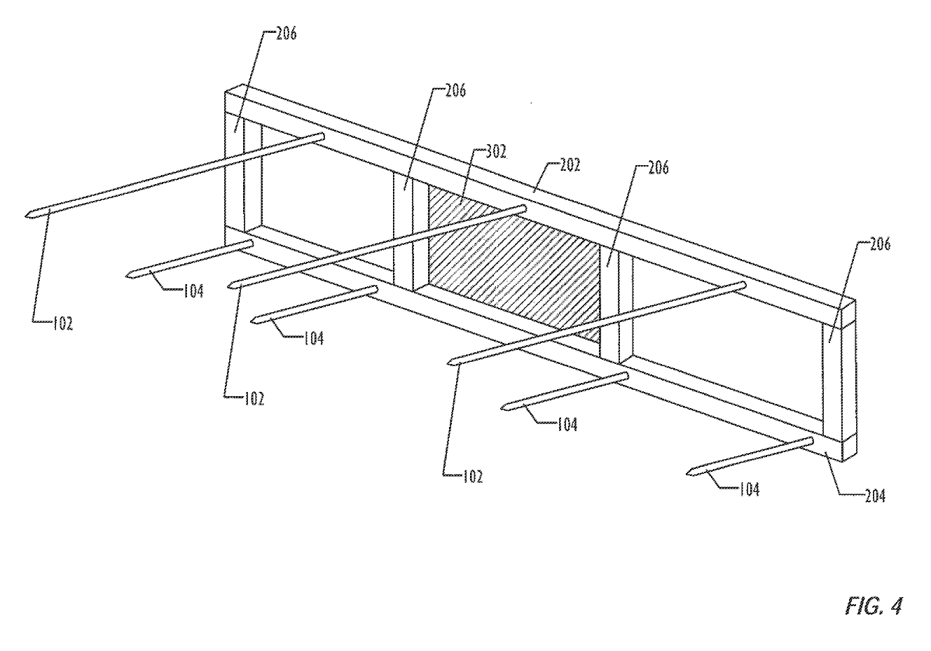

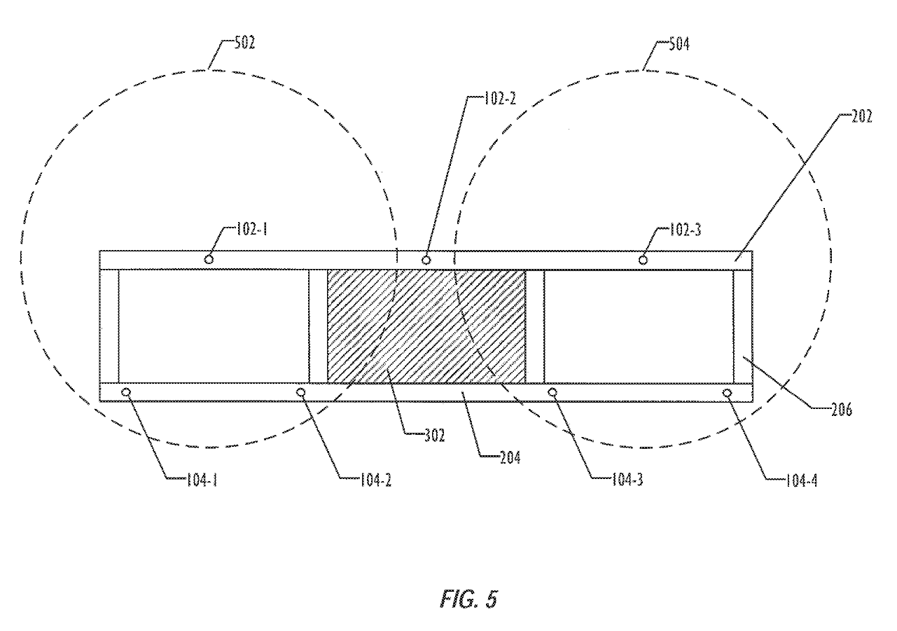

Referring to FIGS. 2 through 4 collectively, a side view, front view, and perspective view, respectively, of the hay bale spear implement of FIG. 1 are depicted. As is illustrated, the spears 102 extend outwardly from an upper horizontal member 202 of the frame 106, and the support spikes 104 extend outwardly from a lower horizontal member 204 of the frame 106. In the depicted embodiment, each of the three spears 102 is flanked below by two adjacent support spikes 104. As will be described in greater detail below, this configuration enables the implement to be utilized to support a variety of shapes and sizes of hay bales.

Attaching the upper horizontal member 202 to the lower horizontal member 204 and providing rigidity to the frame 106 are several vertical members 206. The frame members 202, 204, and 206 can be fastened together in a variety of manners. In one embodiment, the frame members are welded together at each connection point. In another embodiment, a plate may span the joint between two adjoining frame members and may be bolted to the respective frame members on each side of the joint. In another embodiment, the frame 106 may be constructed (e.g., cast) as a single component, in which case no joining of the frame members would be necessary. Although the peripheral frame members are depicted as connecting at a perpendicular joint, they may also be connected at a mitered joint. That is, upper horizontal member 202 and lower horizontal member 204 may join outer vertical members 206 at a 45 degree angle.

In one embodiment, frame members 202, 204, and 206 may be composed of metal tubing of various alloys. For example, the frame members may be composed of 3 inch square metal tubing. In another embodiment, frame members 202, 204, and 206 may be composed of structurally rigid polymers or composites. In a further embodiment, the frame 106 may be constructed as a single plate to which the spears 102 and support spikes 104 may be attached. Additional materials and means of constructing the frame 106 of the hay bale spear implement will be apparent to those of ordinary skill in the art.

On the back side of the implement (i.e., the side opposite the protruding spears and support spikes), a backer plate 302 is removably fastened to one or more frame members 202, 204, and 206. In one embodiment, the backer plate 302 may be removably fastened to the one or more frame members by bolting the backer plate 302 to the one or more frame members. In one embodiment, the backer plate 302 is constructed of sheet metal. However, the backer plate can be constructed of any material that is securely attachable to the frame 106 and is capable of supporting the attachment device 108. As noted above, various attachment devices 108 may be available to allow the implement to be utilized with different vehicles. By way of example, a particular backer plate 302 may comprise a Skid Steer Quick Attach attachment device 108 that attaches directly to a corresponding attachment of a vehicle. Another backer plate 302 may comprise a clamping attachment device 108 that attaches to the cutting edge of a bucket to allow the implement to be utilized without removing the bucket from a vehicle. Additional vendor-specific and custom attachment devices 108 can each be affixed to different backer plates 302. Thus, transitioning between different attachment devices 108 may be accomplished by removing a first backer plate 302 having a first attachment device 108 from the frame 106 and installing a second backer plate 302 having a second attachment device to the frame 106. In one embodiment, an attachment device may be painted a different color from the backer plate and frame members such that the attachment device is easily visible to an operator of a vehicle to allow the operator to quickly attach the attachment device to a corresponding attachment device of the vehicle.

Referring to FIG. 5, in one embodiment, the layout of the spears 102 and the support spikes 104 enables the hay bale spear implement to support two large round hay bales simultaneously. As described herein, the ability to simultaneously support two large round bales refers to the ability to support two large round hay bales of up to six feet in diameter. As illustrated, outer spear 102-1 is inserted near the center of a first large round hay bale 502 and outer spear 102-3 is inserted near the center of a second large round hay bale 504. With the bales supported on the spears 102-1 and 102-3 in this manner, support spikes 104-1 and 104-2 secure the first bale 502 with respect to spear 102-1 and support spikes 104-3 and 104-4 secure the second bale 504 with respect to spear 102-3. That is, the support spikes 104 prevent rotation of the bales about the spears 102 as the bales are transported. Thus, the unique layout of the spears 102 and support spikes 104 enables a user of the implement to retrieve a first round bale 502 using an outer spear 102-1 and the two adjacent support spikes 104-1 and 104-2 and then to retrieve a second round bale 504 using the opposite outer spear 102-3 and its adjacent support spikes 104-3 and 104-4. In the depicted dual round bale configuration, the center spear 102-2 is not utilized. By enabling a user of the implement to support two large round hay bales simultaneously, the improved hay bale spear implement greatly increases the efficiency with which large hay bales can be transported from one location to another.

While the improved hay bale spear implement provides the ability to support two large round hay bales simultaneously, it will often be desirable to transport a single large round hay bale. Although securing a large round bale on each of the outer spears 102-1 and 102-3 as depicted in FIG. 5 provides a secure means of transporting two bales because the weight of the bales is balanced, the torque created by the weight of a single large round bale supported by an outer spear 102 may make such an orientation unacceptable for transporting a single bale, especially over long distances and/or rough terrain. Accordingly, the arrangement of spears 102 and support spikes 104 also provides a means for securely supporting a single large round hay bale for transport.

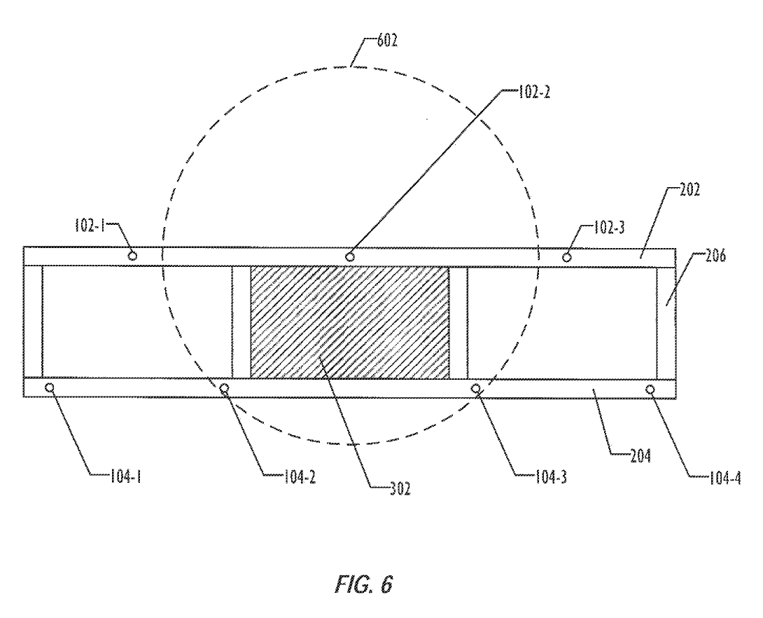

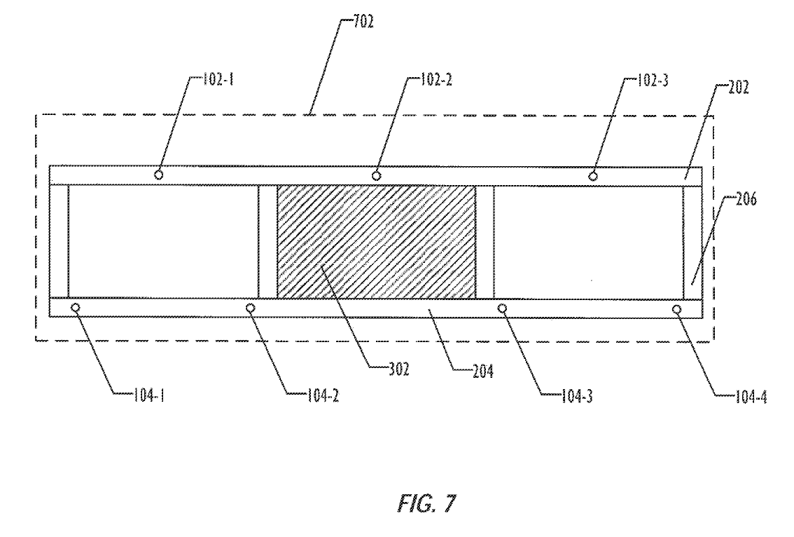

Referring to FIG. 6, a balanced single round hay bale support orientation according to one embodiment of the improved hay bale spear implement is depicted. As illustrated, the center spear 102-2 is inserted near the center of the large round hay bale 602. Center support spikes 104-2 and 104-3 secure the bale 602 on the spear 102-2. According to the depicted orientation, outer spears 102-1 and 102-3 and outer support spikes 104-1 and 104-4 are not utilized. Thus, in addition to providing the capability of transporting two large round hay bales, the layout of the spears 102 and support spikes 104 additionally provides a balanced means for transporting a single large round hay bale.

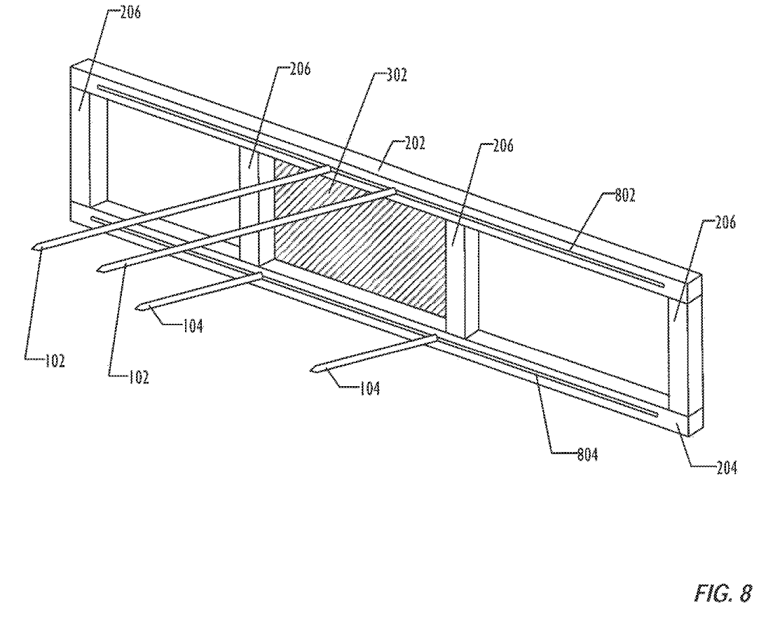

In addition to providing the ability to transport either a single round bale or two round bales, the layout of the spears 102 and support spikes 104 additionally enables the implement to be utilized to transport large rectangular hay bales of various sizes. The insertion of one or more spikes near the center of a large rectangular hay bale will not adequately support the weight of the bale. Such a configuration may lead to the unsupported ends of the bale sagging as the bale is transported and may result in the bale falling apart. As such, existing bale spears designed to support a single large round bale are incapable of securely transporting a large rectangular bale. In order to securely support a large rectangular hay bale, an implement must provide multiple spears and spikes to span the length of the bale. Referring to FIG. 7, the arrangement of spears 102 and support spikes 104 spans the length of even the largest rectangular bales, enabling the implement to transport large rectangular bales of various sizes. As illustrated, the spikes 102 and spears 104 are inserted along the length of the rectangular bale 702. In the depicted orientation, based on the size of bale 702, each of the spears 102 and spikes 104 is utilized. For smaller rectangular bales, not all spears 102 and support spikes 104 will be utilized. However, regardless of the size of the rectangular bale, the bale is supported by inserting as many of the spears 102 and support spikes 104 as is practical along the length of the bale. Accordingly, in one embodiment, the improved hay bale spear implement can be utilized to transport a single large round hay bale, two large round hay bales, and large rectangular hay bales of various sizes.

Referring to FIG. 8, in an alternate embodiment, a hay bale spear implement avows for a user-customizable arrangement of spears 102 and support spikes 104. As illustrated, upper horizontal frame member 202 comprises a spear insertion channel 802 and lower horizontal frame member 204 comprises a support spike insertion channel 804. In one embodiment, the spear insertion channel 802 and support spike insertion channel 801 extend through the upper horizontal frame member 202 and the lower horizontal frame member 204, respectively. In the depicted embodiment, spears 102 may be positioned at any location along the spear insertion channel 802. In one embodiment, a threaded portion of the base of a spear 102 may protrude through the spear insertion channel 802 to the back side of the upper horizontal frame member 202. In such an embodiment, the spear 102 may be secured in a particular location along the spear insertion channel 802 by means of a fastener threaded onto the protruding portion of the spear 102, compressing the upper horizontal frame member 202 between the fastener on the back side of the frame member and a face of the spear 102 on the front side of the frame member. Thus, any number of spears 102 of desired sizes may be positioned at desired locations along the spear insertion channel 802. In the same manner, support spikes 104 may be positioned along the support spike insertion channel 804. Although the depicted embodiment illustrates channels along which spears 102 and support spikes 104 may be positioned, in an alternate embodiment, a user-customizable implement may comprise multiple sockets in lieu of insertion channels) along the lengths of the upper horizontal frame member 202 and lower horizontal frame member 204 in which spears 102 and support spikes 104 may be inserted. For example, the sockets may be situated every 2-4 inches along the upper horizontal frame member 202 and lower horizontal frame member 204 to receive spears 102 and support spikes 104. Such an embodiment would similarly provide a user with the ability to customize the position of spears 102 and support spikes 104 by inserting them in the desired sockets.

The described user-customizable arrangement provides a user of the implement with great flexibility in determining the orientation of spears 102 and support spikes 104 on the implement. Consequently, a user of the implement may customize the orientation of spears 102 and support spikes 104 according to the particular bale or bales to be transported.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instances of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled.

What is claimed is:

1. An apparatus, comprising:
a frame;
two or more spears and two or more support spikes attached to and extending outwardly from the frame, wherein the two or more spears and the two or more support spikes are positioned on the frame to simultaneously support two large round hay bales, each of the two large round hay bales supported by at least one spear and at least one support spike penetrating the bale; and
an attachment device coupled to the frame, the attachment device configured to releasably secure the apparatus to a vehicle.

2. The apparatus of claim 1, wherein the position of the two or more spears and the two or more support spikes on the frame further enables the spears and support spikes to support a large rectangular hay bale.

3. The apparatus of claim 1, wherein the frame comprises:
an upper horizontal frame member;
a lower horizontal frame member; and
two or more vertical frame members connecting the upper horizontal frame member and the lower horizontal frame member.

4. The apparatus of claim 3, wherein the two or more spears are attached to the upper horizontal frame member and the two or more support spikes are attached to the lower horizontal frame member.

5. The apparatus of claim 1, wherein the two or more spears and the two or more support spikes are welded to the frame.

6. The apparatus of claim 1, wherein each of the two or more spears and each of the two or more support spikes has a threaded base portion.

7. The apparatus of claim 6, wherein each of the two or more spears and each of the two or more support spikes is attached to the frame by inserting the threaded base portion into a corresponding threaded socket in the frame.

8. The apparatus of claim 1, wherein the attachment device is coupled to a backer plate that is removably fastened to the frame.

9. The apparatus of claim 1, wherein the attachment device comprises a Skid Steer Quick Attach device.

10. The apparatus of claim 1, wherein the frame is composed of segments of metal tubing.

11. An apparatus, comprising:
an upper horizontal frame member;
a lower horizontal frame member;
at least two vertical frame members attaching the upper horizontal frame member to the lower horizontal frame member;
three spears attached to and extending from the upper horizontal frame member;
four support spikes attached to and extending from the lower horizontal frame member;
a backer plate removably fastened to at least one of the upper horizontal frame member, the lower horizontal frame member, and a vertical frame member; and
an attachment device coupled to the backer plate, the attachment device configured to releasably secure the apparatus to a vehicle;
wherein the position of the spears along the upper horizontal frame member and the position of the support spikes along the lower horizontal frame member enables one or more of the spears and one or more of the support spikes to penetrate and support a single large round hay bale, two large round hay bales, or a large rectangular hay bale for transport by the vehicle.

12. The apparatus of claim 11, wherein the upper horizontal frame member, the lower horizontal frame member, and the two or more vertical frame members are composed of metal tubing.

13. The apparatus of claim 11, wherein the three spears and the four support spikes are attachable at various locations along the upper horizontal frame member and the lower horizontal frame member.

14. The apparatus of claim 11, wherein the three spears are welded to the upper horizontal frame member.

15. The apparatus of claim 11, wherein the three spears are removable from the upper horizontal frame member and the four support spikes are removable from the lower horizontal frame member.

16. The apparatus of claim 11, wherein the attachment device comprises a Skid Steer Quick Attach device.

17. The apparatus of claim 11, wherein the attachment device couples to a bucket of the vehicle.

18. An apparatus, comprising:
a frame;
one or more spears secured in a first channel of the frame, the one or more spears securable at any location along the first channel;
one or more support spikes secured in a second channel of the frame, the one or more support spikes securable at any location along the second channel; and
an attachment device coupled to the frame, the attachment device configured to releasably secure the apparatus to a vehicle;
wherein the one or more spears are positionable within the first channel and the one or more support spikes are positionable within the second channel to penetrate and secure a hay bale for transport by the vehicle.

19. The apparatus of claim 18, wherein the attachment device comprises a Skid Steer Quick Attach device.

20. The apparatus of claim 18, wherein the attachment device couples to a bucket of the vehicle.
